(19) United States
(12) Patent Application Publication
(10) Pub. No.: US 2019/0040997 A1
(43) Pub. Date: Feb. 7, 2019

(54) LUBRICATION SYSTEM INCLUDING A SIGNAL TRANSMISSION ELEMENT

(71) Applicant: SKF Lubrication Systems Germany GmbH, Walldorf (DE)

(72) Inventors: Juergen Kreutzkaemper, Waibstadt-Daisbach (DE); Holger Schmidt, Klein-Machnow (DE); Andreas Schoenfeld, Sankt Leon-Rot (DE)

(21) Appl. No.: 16/027,418

(22) Filed: Jul. 5, 2018

(30) Foreign Application Priority Data
Aug. 4, 2017 (DE) 102017213589.1

(51) Int. Cl. F16N 7/38; F16N 13/22; F16N 13/02; F16N 29/04; H02N 2/18; H02J 7/00; H01F 7/06

(52) U.S. Cl. CPC F16N 7/38; F16N 13/22; F16N 13/02; F16N 29/04; H02N 2/18; F16N 2250/40; H01F 7/06; F16N 2270/70; F16N 2250/04; F16N 2250/18; H02J 7/0052

(57) ABSTRACT

A lubrication system configured to supply a lubricant to at least one lubrication point includes a lubricant pump configured to pump the lubricant to the at least one lubrication point, a lubricant distributor configured to distribute the lubricant at the at least one lubrication point, a controller configured to control at least the lubricant pump and/or the lubricant distributor, a lubrication system monitor configured to monitor a monitoring variable of the lubrication system, and a signal transmission device configured to wirelessly transmit a signal indicative of the monitoring variable provided by the lubrication system monitor to the control device and/or to a device functionally associated with the lubrication system and/or to receive data from the control device or from the device functionally associated with the lubrication system.

### CROSS-REFERENCE

This application claims priority to German patent application no. 10 2017 213 589.1 filed on Aug. 4, 2017, the contents of which are fully incorporated herein by reference.

### TECHNOLOGICAL FIELD

The present disclosure relates to a lubrication system for supplying at least one lubrication point with lubricant, wherein the lubrication system includes at least one lubricant pumping device that pumps the lubricant in the lubrication system to the lubrication point, a lubricant distributor device that distributes lubricant at the lubrication point, and a control device that controls at least the lubricant pumping device and/or the lubricant distributor device.

### BACKGROUND

There are lubrication systems in a variety of designs in order to provide lubricant at a point to be lubricated. Here a lubrication system usually includes a lubricant pumping device, such as, for example, a lubricant pump, and a lubricant line, via which lubricant is pumped from the lubricant pumping device to the point to be lubricated. Furthermore, at the point to be lubricated a lubricant distributor device is provided that distributes lubricant at the point to be lubricated, wherein the lubricant distributor device additionally often also meters the amounts dispensed. In order to achieve as good a lubricant distribution in the system as possible, the lubrication system is usually centrally controlled via a control device that monitors and controls at least the lubricant pumping device and the lubricant distributor device. For this purpose the control device is usually connected by cable to the lubrication system components in order to on the one hand control the lubricant systems and also to receive signals from the lubrication system components. In addition to the components to be controlled, a variety of lubrication system monitoring devices or sensors are also present in the lubrication system, which monitor, examine, or detect the lubricant distribution or the lubricant stream. These lubrication system monitoring devices or sensors are also connected to the control device by cable and transmit their monitoring variables to the control device.

However, it is disadvantageous in the conventional lubrication systems that the cabling within the lubrication system is often very complex and partially disruptive. Furthermore, some lubrication system components or parts thereof cannot be connected to lubrication system monitoring devices or sensors, since a cabling of these lubrication system monitoring devices or sensors is not possible.

### SUMMARY

An aspect of the present disclosure is therefore to provide a lubrication system wherein the control unit of the lubrication system can also receive signals from components or parts that are disposed in difficult-to-access locations.

In the following a lubrication system for supplying at least one lubrication point with lubricant is presented, wherein the lubrication system includes at least one lubricant pumping device that pumps the lubricant in the lubrication system to the lubrication point, a lubricant distributor device that distributes lubricant at the lubrication point, and a control device that controls at least the lubricant pumping device and/or the lubricant distributor device. Furthermore, the lubrication system includes at least one lubrication system monitoring device, which monitors a monitoring variable of the lubrication system.

In order to also be able to control the lubrication system based on monitoring variables of lubrication system monitoring devices that are disposed in difficult-to-access locations, the lubrication system furthermore includes at least one signal transmission device that is designed to wirelessly transmit a signal corresponding to monitoring values provided by the lubrication system monitoring device to the control device and/or to a device functionally associated with the lubrication system or to receive a signal from the control device or device functionally associated with the lubrication system. Accordingly the signal transmission device is preferably not only designed to send signals, but also to receive.

In the following a device that can both receive and send signals, or only send signals, or only receive signals is subsumed under the term “signal transmission device.”

A device functionally associated with the lubrication system can be, for example, a display unit that displays the signals of the lubrication system monitoring device. But they can also be any other components directly or indirectly associated with the lubrication system, which in particular can directly or indirectly influence the functionality of the lubrication system. Thus, for example, a signal provided by a lubrication system monitoring device can be made accessible to an operator in a purely visible manner; the operator then, for example, carries out manual adjustments on the lubrication system. However, the device and/or the control unit can also be disposed in a central machine control room; the device and/or control unit then monitors and controls a variety of machines and/or associated equipment articles in addition to the lubrication system.

Here this signal transmission can be effected continuously and/or discontinuously. For example, the signal transmission can be dependent on the lubrication system monitoring device. Thus, for example, real-time sensors, such as, for example, a temperature sensor, provide a continuous signal current, while, for example, pressure-limit sensors only emit a signal when a threshold value is reached. In addition to the type of the lubrication system monitoring device, the type of the energizing of the signal transmission unit and/or of the lubrication system monitoring device can also be relevant to the manner of signal transmission. If, for example, the signal transmission device is continuously supplied with current, for example, by a central power grid or a battery, a continuous signal transmission is easier to achieve than with a power supply using self-sufficient energy-generating elements. These self-sufficient energy-generating elements and/or a battery provide a limited amount of energy that is exhausted more quickly by a continuous signal transmission than with a discontinuous signal transmission.

According to a further advantageous exemplary embodiment, the control device can directly control the lubricant pumping device and/or the lubricant distributor device based on the wirelessly transmitted signal. Thus, for example, an automated monitoring of the lubrication system can be achieved.

Furthermore, the signal transmission device can be attached directly to a lubrication system component, such as, for example, the lubrication system monitoring device, or to the lubrication system component monitored by the lubrication system monitoring device; however, it is also possible that the signal transmission device is present in the lubrication system as an independent lubrication system component. Here a lubrication system monitoring device can also be used, for example, at difficult-to-access locations that can nonetheless transmit their monitoring variables to the control device.

According to a further advantageous exemplary embodiment the at least one signal transmission device is contained in the lubricant pumping device and/or the lubricant distributor device and/or a further lubrication system component. Due to the direct integration of the signal transmission device in the components of the lubrication system a very simple and rapid signal transmission can be effected within the lubrication system. The signal transmission device itself here can be fixedly built-in into the component of the lubrication system, and benefits in this installation situation, for example, from a central energy supply that supplies the lubrication system component and thus also the signal transmission device with energy. The installation in the lubrication system component itself simultaneously makes it possible that the lubrication system monitoring device, which, for example, is also provided in the lubrication system component, can directly communicate in a cabled manner with the signal transmission device, so that signals can be sent from the lubrication system component to the control device or received from it via only one interface.

According to one further advantageous exemplary embodiment the lubrication system monitoring device furthermore includes at least one sensor that detects at least one monitoring variable of the lubrication system. Here it is advantageous in particular if the lubrication system monitoring device or the sensor the includes at least one signal transmission device that wirelessly transmits the signal that is associated with the detected monitoring variable to the control device. Sensors especially can be necessary at difficult-to-access locations in the lubrication system, at which locations a wired connection to the control device is often not possible. Due to the wireless signal transmission device sensors can therefore also be disposed at locations in the lubrication system that previously were not accessible for a sensor assembly, since no signal transmission possibility from the sensor to the control device was possible.

According to a further advantageous exemplary embodiment the lubrication system monitoring device is, for example, a pressure switch, a fill-level switch, a flow sensor, a piston sensor, and/or a valve. Thanks to the wireless signal transmission any desired positioning in the lubrication system is also possible with these elements.

According to a further advantageous exemplary embodiment the lubricant pumping device is a lubricant pump and/or the lubricant distributor device is a single-line distributor, a multi-line distributor, a progressive distributor, a flow-limiting unit, a flow-throttling unit, a lubricant metering unit, and/or a valve. Of course, still further components can be provided in the lubrication system, and it is also possible that they function other than as the above-mentioned examples of lubricant pumping device or lubricant distributor device.

According to a further advantageous exemplary embodiment the lubrication system furthermore includes an energy-supplying device that at least partially supplies the energy for the signal transmission device and/or the lubrication system monitoring device. This energy-supplying device can be, for example, a battery, a central power supply, and/or an energy-generating device that generates energy, for example, by inductance or one or more piezo elements. Since the lubrication system components often function electrically and are equipped with a power supply, the signal transmission device can be easily connected to this already-existing power supply. If such a connection is difficult, then either a battery can assume this task or energy can be directly generated on the signal transmission device, for example, via induction or deformation energy. For this purpose it is advantageous in particular if a component of the lubrication system and/or a lubricant line connected to the components of the lubrication system includes a moving element, and the energy-generating element interacts with the moving element and generates the energy required by the signal transmission device.

Signal transmission devices can thereby be disposed at locations that were previously not accessible to a signal transmission possibility.

Further advantages and advantageous embodiments are specified in the description, the drawings, and the claims. Here in particular the combinations of features specified in the description and in the drawings are purely exemplary, so that the features can also be present individually or combined in other ways.

In the following the disclosure is described in more detail using the exemplary embodiments depicted in the drawings. Here the exemplary embodiments and the combinations shown in the exemplary embodiments are purely exemplary and are not intended to define the scope of the disclosure. This scope is defined solely by the appended claims.

### BRIEF DESCRIPTION OF THE DRAWING

FIG. 1 shows a schematic depiction of a first preferred exemplary embodiment of a lubrication system according to the present disclosure.

### DETAILED DESCRIPTION

In the following, identical or functionally equivalent elements are designated by the same reference numbers.

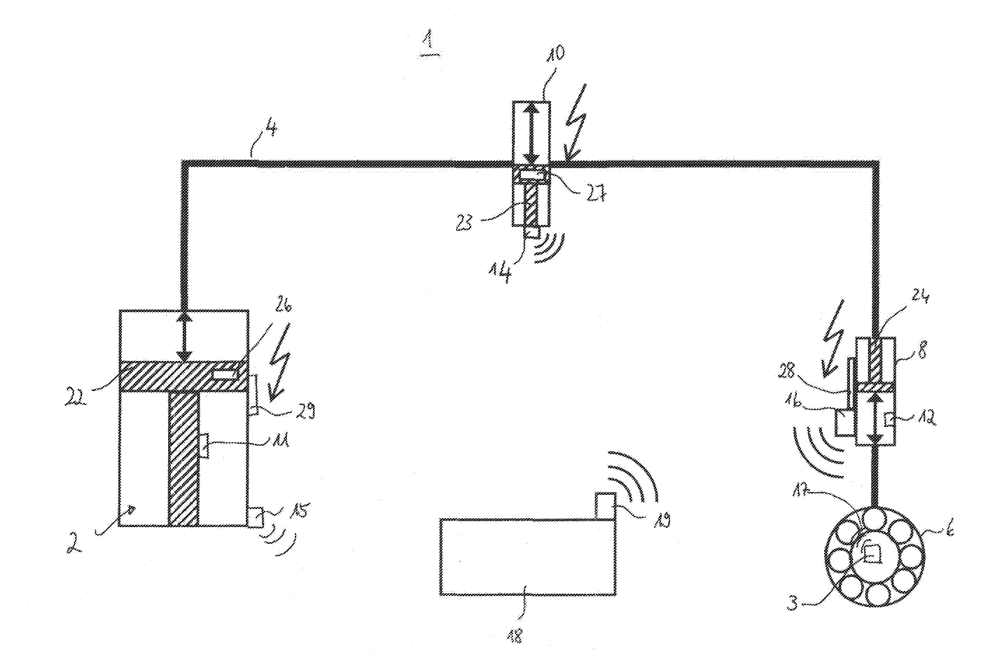

FIG. 1 schematically shows a lubrication system 1 including a lubricant pumping device 2 that is connected to a lubricant line 4 in order to pump lubricant to a to-be-lubricated point 6 that is depicted here as a bearing. In order to deliver a precisely metered amount of lubricant or distribute lubricant generally onto the bearing, a lubricant distributor device 8 is furthermore provided that is disposed upstream of the bearing 6. The lubricant distributor device can be, for example, a single-line distributor or progressive distributor. As can be further seen from FIG. 1, a lubrication system monitoring device is furthermore provided on the lubricant line 4 in the form of a sensor 10, which, for example, monitors a lubricant flow through the line 4, or its temperature or viscosity. In the exemplary embodiment depicted in FIG. 1 the lubrication system monitoring device 10 is a pressure switch that measures the pressure of the lubricant transported in the lubricant line 4.

As further depicted in FIG. 1, the lubrication system 1 includes a signal transmission device 14, using which a monitoring variable of the lubrication system monitoring device 10 can be transmitted to a remotely disposed control device 18 or to a remotely disposed operator or received from it. Alternatively or additionally a signal can also be issued by the control device 18, which signal, for example, is received by the signal transmission device 14 of the lubricant distributor device 8 in order to control the amount of lubricant to be dispensed on the bearing 6. For this purpose the control device 18 also includes a signal transmission device 19.

It is clear from the exemplary embodiment depicted in FIG. 1 that the lubrication system includes further lubrication system monitoring devices 11, 12, 13 so that the lubrication system 1 can also be controlled based on monitoring variables of lubrication system monitoring devices 11, 12, 13 that are disposed in difficult-to-access locations. For this purpose further signal transmission devices 15, 16, 17 are provided in the lubrication system, which are designed to wirelessly transmit a signal corresponding to monitoring values provided by the lubrication system monitoring devices 11, 12, 13 to the control device 18 or to receive from it. Here a lubrication system monitoring device 13 or a signal transmission device 17 can also be disposed at the point to be lubricated.

The lubrication system monitoring device 10, 11, 12, 13 and the signal transmission device 14, 15, 16, 17, 19 can be separate elements; however, it is also possible that the lubrication system monitoring device 10, 11, 12, 13 and the signal transmission device 14, 15, 16, 17, 19 are formed integrally.

Furthermore, the signal transmission device 14, 15, 16, 17, 19 can be directly attached to the lubrication system component 2, 4, 6, 8, 10, 18 monitored by the lubrication system monitoring device 10, 11, 12, 13; however, it is also possible that the signal transmission device 14, 15, 16, 17, 19 is present in the lubrication system 1 as an independent lubrication system component.

If the signal transmission device 14, 15, 16, 17, 19 is directly integrated into the components of lubrication system 1, a very simple and rapid signal transmission can be effected within the lubrication system 1. The signal transmission device 14, 15, 16, 17, 19 itself here can be fixedly built-in into the component of lubrication system 1 and benefit in this installation situation, for example, from a central energy supply (not depicted) that supplies the lubrication system component 2, 4, 6, 8, 10, 18 and thus also the signal transmission device 14, 15, 16, 17, 19 with energy. The installation in the lubrication system component 2, 4, 6, 8, 10, 18 itself simultaneously makes it possible that the lubrication system monitoring device 10, 11, 12, 13, which is, for example, also provided in the lubrication system component 2, 4, 6, 8, 10, 18, can communicate in a cabled manner with the signal transmission device 14, 15, 16, 17, 19 so that signals are sent from the lubrication system component 2, 4, 6, 8, 10, 18 to the control device 18 or received from it via only one interface.

As furthermore schematically depicted in FIG. 1 the lubricant pumping device 2, the lubricant distributor device 8, and the sensor unit 10 include pistons 22, 23, 24 that ensure a distributing or pumping or metering of lubricant. These pistons 22, 23, 24 exemplarily represent moving elements. The moving elements, here the pistons 22, 23, 24, furthermore interact with energy-generating elements 26, 27, 28, 29, wherein an inductive element 28 is schematically disposed on the lubricant distributor element 8, while piezo elements 26, 27 are provided on the lubricant pumping device 2 and on the sensor 10. Here the components 2, 4, 8, 10 of the lubrication system include not just one type of energy-generating element; rather, it is also possible, as shown, for example, in the lubricant pumping device 2, to provide different energy generating elements 26, 29 on a component. Thus, for example, an inductive energy-generating element 29 can further be provided on the lubricant pumping device 2.

These energy-generating elements function in a known manner, wherein the piezo elements obtain electrical energy from a deforming of the element, while the inductive elements generate current via two coils moved with respect to each other. These energy-generating elements interact with the moving elements in order to generate energy that is provided for use in the lubrication system 1. The energy generation is illustrated by the symbol for current.

This energy can be supplied, for example, to the lubrication system monitoring devices and/or signal transmission devices.

Furthermore, at least one energy storage unit (not depicted) can be provided in the lubrication system 1, which energy storage unit interacts with the energy generating elements to store energy for a later or energetic application. Thus, for example, an emergency power supply for a motor (not depicted) of the lubricant pumping device 2 can be provided via the stored energy. The energy transfer between energy storage unit and energy consumers can be effected, for example, using a cabling.

Overall, using the inventive lubrication system a lubrication system can be provided whose individual and often difficult-to-access components can be equipped with lubrication system monitoring devices without these lubrication system monitoring devices having to be cabled to the control device. Due to the wireless signal transmission in the system a lubrication system can be provided that can be monitored in a simpler and more precise manner. Since the signal transmission devices and/or the lubrication system monitoring devices consume only relatively little energy, it is also possible to use energy-generating elements such as, for example, piezo elements and/or induction elements in order to directly generate the required energy themselves.

As used herein, a “controller” may comprise, for example, a microprocessor and/or may be implemented in hardware and/or in software. The implementation can be performed using a digital storage medium, for example a ROM, a RAM, a PROM, an EPROM, an EEPROM or a flash memory, on which electronically readable control signals are stored, which interact or can interact with a programmable hardware component such that the respective method is performed.

A programmable hardware component can be formed by one or more of a processor, a computer processor (CPU=central processing unit), a graphics processor (GPU=graphics processing unit), a computer, a computer system, an application-specific integrated circuit (ASIC), an integrated circuit (IC), a system-on-a-chip (SOC), a programmable logic element, or a field programmable gate array (FGPA) including a microprocessor.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved lubrication systems.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

1 Lubrication system
2 Lubricant pumping device
4 Lubricant line
6 To-be-lubricated point
8 Lubricant distributor device
10, 11, 12, 13 Lubrication system monitoring device
14, 15, 16, 17 Signal transmission device
18 Control device
19 Signal transmission device
22, 23, 24 Piston
26, 27, 28, 29 Energy-generating elements

What is claimed is:

1. A lubrication system configured to supply a lubricant to at least one lubrication point, the lubrication system comprising:
a lubricant pump configured to pump the lubricant to the at least one lubrication point,
a lubricant distributor configured to distribute the lubricant at the at least one lubrication point,
a controller configured to control at least the lubricant pump and/or the lubricant distributor,
a lubrication system monitor configured to monitor a monitoring variable of the lubrication system, and
a signal transmission device configured to wirelessly transmit a signal indicative of the monitoring variable provided by the lubrication system monitor to the control device and/or to a device functionally associated with the lubrication system and/or to receive data from the control device or from the device functionally associated with the lubrication system.

2. The lubrication system according to claim 1, wherein the signal transmission device is discontinuously powered and/or is configured to discontinuously transmit the signal.

3. The lubrication system according to claim 1, wherein the controller is configured to control the lubricant pump and/or the lubricant distributor based on the wirelessly transmitted signal.

4. The lubrication system according to claim 1, wherein the device functionally associated with the lubrication system is a display unit.

5. The lubrication system according to claim 1, wherein the signal transmission device is contained in the lubricant pump and/or the in the lubricant distributor and/or in a further lubrication system component.

6. The lubrication system according to claim 1, wherein the lubrication system monitor includes the at least one signal transmission device.

7. The lubrication system according to claim 1, wherein the lubrication system monitor includes at least one sensor configured to detect the at least one monitoring variable of the lubrication system.

8. The lubrication system according to claim 1, wherein the lubrication system monitor is a pressure switch, a fill-level switch, a flow sensor, a piston sensor, and/or a valve.

9. The lubrication system according to claim 1,
wherein the lubricant distributor is a single-line distributor, a double-line distributor, a multi-line distributor, a progressive distributor, a flow limiter, a flow-throttle unit, a lubricant metering unit, and/or a valve.

10. The lubrication system according to claim 1, wherein the lubrication system further includes an energy-supplying device configured to supply energy to the signal transmission device and/or to the lubrication system monitor.

11. The lubrication system according to claim 10, wherein the energy-supplying device is a battery, a central power supply, and/or an energy-generating device.

12. The lubrication system according to claim 1, wherein a component of the lubrication system and/or a lubricant line connected to one of the components of the lubrication system includes at least one moving element, and the energy-generating element interacts with the moving element and generates the energy required by the signal transmission device.

13. The lubrication system according to claim 10, wherein the energy-generating element is a piezo element and/or an inductive element.

14. The lubrication system according to claim 1,
wherein the signal transmission device is discontinuously powered and/or is configured to discontinuously transmit the signal,
wherein the controller is configured to control the lubricant pump and/or the lubricant distributor based on the wirelessly transmitted signal,
wherein the device functionally associated with the lubrication system is a display unit,
wherein the signal transmission device is contained in the lubricant pump and/or the in the lubricant distributor, and
wherein the lubrication system monitor includes the at least one signal transmission device and at least one sensor configured to detect at least one monitoring variable of the lubrication system.

15. The lubrication system according to claim 14,
wherein the lubrication system monitor is a pressure switch, a fill-level switch, a flow sensor, a piston sensor, and/or a valve,
wherein the lubricant distributor is a single-line distributor, a double-line distributor, a multi-line distributor, a progressive distributor, a flow limiter, a flow-throttle unit, a lubricant metering unit, and/or a valve, and
wherein the lubrication system further includes a battery, a central power supply, and/or an energy-generating device configured to supply energy to the signal transmission device and/or to the lubrication system monitor.

16. The lubrication system according to claim 15,
wherein a component of the lubrication system and/or a lubricant line connected to one of the components of the lubrication system includes at least one moving element, and the energy-generating element interacts with the moving element and generates the energy required by the signal transmission device.

17. The lubrication system according to claim 16, wherein the energy-generating element is a piezo element and/or an inductive element.
